(19) United States
(12) Patent Application Publication
(10) Pub. No.: US 2024/0290305 A1
(43) Pub. Date: Aug. 29, 2024

(54) MUSIC GENERATION METHOD AND APPARATUS, DEVICE, STORAGE MEDIUM, AND PROGRAM

(71) Applicant: Beijing Zitiao Network Technology Co., Ltd., Haidian District, Beijing (CN)

(72) Inventors: Chenlei YU, Beijing (CN); Mingquan KANG, Beijing (CN); Haidong CHEN, Beijing (CN); Rong BAI, Beijing (CN); Zhiwen HOU, Beijing (CN); Xiao TAN, Beijing (CN); Zhuowen CHEN, Beijing (CN)

(21) Appl. No.: 18/571,086

(22) PCT Filed: Sep. 28, 2022
(86) PCT No.: PCT/CN2022/122334

§ 371 Date: Dec. 15, 2023

(30) Foreign Application Priority Data
Sep. 28, 2021 (CN) 202111140485.0

(51) Int. Cl. G10H 1/00

(52) U.S. Cl. CPC G10H 1/0025; G10H 2210/081; G10H 2210/111; G10H 2210/555; G10H 2220/455

(57) ABSTRACT

A method for generating music and apparatus, a device, an electronic device, a computer readable storage medium, a computer program product, and a computer program. The method comprises: acquiring a first video of first user captured within a preset duration; determining, action information of a first action performed by the first user within the preset duration according to the first video, the action information comprising an action type and a duration of action; and then generating, according to the action information of the first action, target music corresponding to the preset duration. By means of the process, a user can interact with a terminal device by performing a series of actions to achieve music creation, which improves the interactivity and fun of the music creation process, thereby improving user experience.

### CROSS-REFERENCE TO RELATED APPLICATION(S)

The present disclosure claims priority to Chinese Patent Application No. 202111140485.0, filed to the Chinese Patent Office on Sep. 28, 2021 and entitled “MUSIC GENERATION METHOD AND APPARATUS, DEVICE, STORAGE MEDIUM, AND PROGRAM”, which is incorporated in its entirety herein by reference.

### FIELD

Embodiments of the present disclosure relate to the technical field of artificial intelligence, and particularly, relate to a method and apparatus for generating music, a device, an electronic device, a computer-readable storage medium, a computer program product, and a computer program.

### BACKGROUND

With the development of terminal technology, a user may hope to create music by means of a terminal device, thus increasing pleasure of music creation.

In related art, piano keys may be displayed on a screen of the terminal device. Users may simulate playing the piano by touching the keys on the screen, so as to create music.

However, the method for creating music described above is monotonous and poorly interactive.

### SUMMARY

Embodiments of the present disclosure provide a method and apparatus for generating music, a device, an electronic device, a computer-readable storage medium, a computer program product, and a computer program, so as to solve a problem of poor interactivity of a music creation mode.

In a first aspect, an embodiment of the present disclosure provides a method for generating music. The method includes:
acquiring a first video of a first user captured within a preset duration;
determining action information of a first action performed by the first user within the preset duration according to the first video, the action information includes an action type and a duration of action; and
generating target music corresponding to the preset duration according to the action information of the first action.

In a second aspect, an embodiment of the present disclosure provides an apparatus for generating music. The apparatus includes:
an acquiring module configured to acquire a first video of a first user captured within a preset duration;
a determination module configured to determine action information of a first action performed by the first user within the preset duration according to the first video, the action information includes an action type and a duration of action; and
a generation module configured to generate target music corresponding to the preset duration according to the action information of the first action.

In a third aspect, an embodiment of the present disclosure provides an electronic device. The electronic device includes: a processor and a memory.

The memory stores computer-executable instructions.

The processor executes the computer-executable instructions so as to implement the method for generating music according to the first aspect and various possible implementations of the first aspect.

In a fourth aspect, an embodiment of the present disclosure provides a computer-readable storage medium. The computer-readable storage medium stores computer-executable instructions. A processor, when executes the computer-executable instruction, implements the method for generating music according to the first aspect and various possible implementations of the first aspect.

In a fifth aspect, an embodiment of the present disclosure provides a computer program product. The computer program product includes a computer program. The computer program, when being executed by a processor, implements the method for generating music according to the first aspect and various possible implementations of the first aspect.

In a sixth aspect, an embodiment of the present disclosure provides a computer program. The computer program, when being executed by a processor, implements the method for generating music according to the first aspect and various possible implementations of the first aspect.

In the method and apparatus for generating music, the device, the electronic device, the computer-readable storage medium, the computer program product, and the computer program according to the embodiments of the present disclosure, the method includes: acquiring the first video of the first user captured within the preset duration; determining the action information of the first action performed by the first user within the preset duration according to the first video, the action information includes the action type and a duration of action; and further generating the target music corresponding to the preset duration according to the action information of the first action. Through the above process, the user can interact with a terminal device by performing a series of actions, so as to create music, which improves interactivity and pleasure of a music creation process and further enhances user experience.

### BRIEF DESCRIPTION OF THE DRAWINGS

In order to more clearly describe technical solutions in embodiments of the present disclosure or in the related art, the accompanying drawings required for description of the embodiments or the related art will be briefly introduced below. Obviously, the accompanying drawings in the following description are some embodiments of the present disclosure. Those of ordinary skill in the art would also derive other accompanying drawings from these accompanying drawings without making inventive efforts.

FIG. 1 is a schematic diagram of an application scenario according to an embodiment of the present disclosure;

FIG. 2 is a schematic flow diagram of a method for generating music according to an embodiment of the present disclosure;

FIG. 3 is a schematic flow diagram of another method for generating music according to an embodiment of the present disclosure;

FIG. 4 is a schematic diagram of a display interface according to an embodiment of the present disclosure;

FIG. 5 is a schematic diagram of another display interface according to an embodiment of the present disclosure;

FIG. 6 is a schematic diagram of yet another display interface according to an embodiment of the present disclosure;

FIG. 7 is a schematic structural diagram of an apparatus for generating music according to an embodiment of the present disclosure; and

FIG. 8 is a schematic structural diagram of an electronic device according to an embodiment of the present disclosure.

### DETAILED DESCRIPTION OF EMBODIMENTS

For making objectives, technical solutions and advantages of embodiments of the present disclosure more obvious, the technical solutions according to embodiments of the present disclosure will be clearly and completely described below in conjunction with the accompanying drawings in the embodiments of the present disclosure. Obviously, the described embodiments are some embodiments rather than all the embodiments of the present disclosure. Based on the embodiments of the present disclosure, all other embodiments obtained by those of ordinary skill in the art without making creative efforts fall within the protection scope of the present disclosure.

Firstly, concepts and terms involved in the embodiments of the present disclosure will be explained.

Scale: a scale is formed by arranging notes in a mode from a keynote to the keynote, from low to high (called ascending), or from high to low (called descending).

Different regions generally use different scale systems. Currently, a natural heptatonic scale is the most widely used heptatonic scale, and has an interval organization in which five whole notes exist in each octave and are divided into a string having two whole notes and a string having three whole notes, and two strings are separated by a semit. Seven scales are: 1(Do), 2(Re), 3(Mi), 4(Fa), 5(So), 6(La), and 7(Si).

It should be noted that embodiments of the present disclosure do not limit to a scale system and may be applied to any scale system. In some embodiments, for the purposes of convenience for understanding, the natural heptatonic scale is taken as an instance for illustration.

Tone: different sounds generally have different characteristics in waveform, and different objects have different characteristics in vibration. Different sounding objects have different tones due to their different materials and structures. For instance, a piano, a violin and a person make different sounds, and various people make different sounds. Therefore, tone may be understood as a characteristic of sounds.

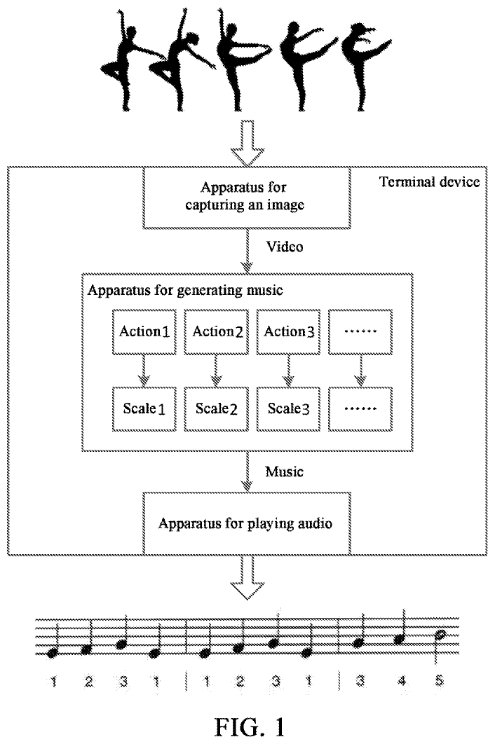

For convenience of understanding of the technical solutions of the present disclosure, an application scenario of an embodiment of the present disclosure will be introduced below in conjunction with FIG. 1.

FIG. 1 is a schematic diagram of an application scenario according to an embodiment of the present disclosure. As shown in FIG. 1, the application scenario involves a terminal device. The terminal device is provided with an apparatus for capturing a video, such as a camera. The terminal device is further provided with an apparatus for playing audio, such as a speaker. The terminal device is further provided with an apparatus for generating music. The apparatus for generating music may be in a form of software and/or hardware. For instance, the apparatus for generating music may be a processor, a chip, a chip module, a module, a unit, an application, etc. in the terminal device.

With reference to FIG. 1, an apparatus for capturing an image may capture an action (for instance, body actions, a face expression, a gesture, etc.) of a user, so as to obtain a video. The apparatus for capturing an image transmits the video to the apparatus for generating music. The apparatus for generating music may generate music based on the video. For instance, with reference to FIG. 1, the apparatus for generating music may recognize and obtain an action sequence of the user from the video, and map the action of the user into scales, so as to obtain a scale sequence. Then, music may be generated according to the scale sequence. The apparatus for generating music may transmit the generated music to the apparatus for playing audio, and the apparatus for playing audio plays the music.

In the above application scenario, a user may enable the terminal device to generate different music pieces by executing different action sequences, so as to create music. In a music creation process, the user may interact with the terminal device by executing a series of actions, so as to create music, which improves interactivity and pleasure and may further enhance user experience.

The terminal device according to embodiments of the present disclosure may be any electronic device having an apparatus for capturing a video and an apparatus for playing audio, including, but not limited to, a smart phone, a tablet computer, a notebook computer, a smart television, a smart wearable device, a smart home device, etc.

The technical solution of the present disclosure will be described in detail below in conjunction with the specific embodiments. The following several specific embodiments may be combined with each other, and the same or similar concepts or processes may not be repeated in some embodiments.

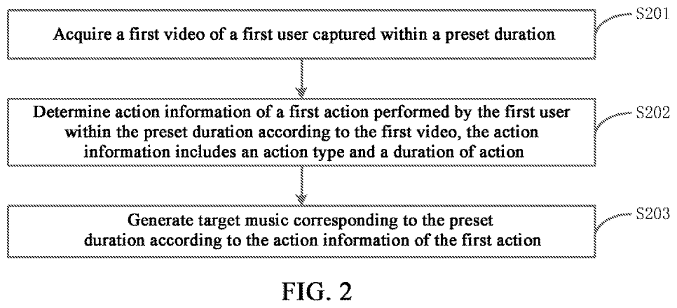

FIG. 2 is a schematic flow diagram of a method for generating music according to an embodiment of the present disclosure. The method according to the embodiment may be executed by a terminal device, or an apparatus for generating music in a terminal device. As shown in FIG. 2, the method according to the embodiment may include the following steps:

S201: acquiring a first video of a first user captured within a preset duration.

The embodiment is applied to a scenario where the first user may create target music.

The preset duration indicates execution granularity of the embodiment in the time dimension. When the embodiment is executed, the first video captured within a preset duration is obtained according to the preset duration, and target music corresponding to a first preset duration is generated based on the first video. The preset duration may also be referred to as a time window. Generally, the preset duration may be set to be a small value, for instance, 1 second, 100 milliseconds, etc. For instance, the preset duration may be a duration in which a user performs an action.

It may be understood that the user generally needs to repeat the embodiment when creating a music piece. When the embodiment is executed for different times, the corresponding preset duration may be the same or not. In this way, target music corresponding to multiple preset durations are combined into final complete music.

An embodiment may be executed through the following two methods:

Method one: a music generation process and a video capture process are conducted synchronously. That is, the method of the embodiment is executed synchronously when a video of the first user is captured, such that capturing videos and generating music based on the videos occur synchronously. Specifically, with reference to FIG. 1, every time an apparatus for capturing a video captures the first video of the preset duration, the apparatus transmits the first video to the apparatus for generating music, and the apparatus for generating music generates the target music corresponding to the preset duration based on the first video.

Method two: a music generation process and a video capture process are conducted asynchronously. For instance, an apparatus for capturing a video captures a second video of the user. For instance, a duration of the second video may last 3 minutes or 5 minutes. The second video may be a complete video of dancing of the user. The second video captured is stored in a preset storage space. At a certain time instant after completion of video capture, the apparatus for generating music obtains the second video from the preset storage space, determines the preset duration as time granularity, obtains the first video corresponding to the preset duration from the second video, and generates the target music corresponding to the preset duration according to the first video.

S202: determining action information of a first action performed by the first user within the preset duration according to the first video, the action information includes an action type and a duration of action.

In the embodiment, the first action is an action performed by a preset body part of the first user. For instance, the first action may be a body movement such as lifting a leg, lifting an arm, twisting a waist, and bending down. The first action may be a gesture, such as a clapping gesture, an OK gesture, and a V-sign gesture. Alternatively, the first action may be a face expression, such as a smiling expression, a laughing expression, a pouting expression, and a surprised expression.

In one possible implementation, the action information of the first action may be determined as follows: determining a target body part, the target body part includes at least one of the following parts of the first user: limbs and trunk, a hand, and a face; detecting feature information of the target body part in multiple frames of the first video respectively; and determining the action information of the first action according to the feature information of the target body part detected in the multiple frames.

The action information of the first action includes: the action type of the first action and the duration of the first action. The duration of the first action may refer to a holding duration of the first action, or the sum of time taken to complete the first action and a holding duration of the first action.

For instance, taking the target body part being limbs and a trunk for an example. Assuming that the first video includes 12 frames, for each frame, the limbs and trunk in the image frame are recognized with a target recognition algorithm respectively, and feature information of the limbs and trunk is obtained. For instance, a left arm naturally droops in frame 1, an included angle between a left arm and trunk in frame 2 is 30 degrees, an included angle between the left arm and the trunk in image frame 3 is 60 degrees, an included angle between the left arm and the trunk in image frame 4 is 90 degrees, and an included angle between the left arm and the trunk in image frame 5 is 120 degrees. Included angles between the left arm and the trunk in image frame 6 to frame 12 are 180 degrees, respectively. In this way, according to the feature information of the limbs and trunk recognized from the above frames, the action type of the first action is determined to be “lifting a left arm”. Further, a time interval between frame 1 and frame 12 may be regarded as the duration of the first action, Alternatively, a time interval between frame 6 and frame 12 may be regarded as the duration of the first action.

Alternatively, in order to improve detection efficiency of the first action, the first video may be sampled according to a preset sampling rule, and a recognition process of the target body part may be conducted on each sampled frame, such that real-time performance of a detection result of the first action may be improved.

S203: generating target music corresponding to the preset duration according to the action information of the first action.

A music piece is generally composed of a variety of musical elements, such as scales, tones, and tunes. In the embodiment of the present disclosure, a correspondence between different actions and music elements may be defined in advance. In this way, with the correspondence, the first action may be mapped to related information of a music element, such that the target music may be generated.

In some instances, a correspondence between body movements and scales may be defined, that is, different body movement types correspond to different scale types. In another instance, a correspondence between face expressions and tones may be defined, that is, different face expressions correspond to different tones. In still another instance, a correspondence between gestures and tunes may be defined, that is, different gestures correspond to different tunes. It should be noted that the above correspondences are only some possible instances. The above different instances may be used in combination with each other.

In a possible implementation, illustration will be provided below with mapping of different actions to different scales as an example. Scale information of a target scale corresponding to the first action may be determined according to the action information of the first action. The scale information includes a scale type and duration.

For instance, the scale type of the target scale may be determined according to the action type of the first action and a preset correspondence. The preset correspondence is configured to indicate a correspondence between different action types and different scale types. The preset correspondence may be shown in Table 1.

TABLE 1

| Action type | Scale type |
|---|---|
| Lift a left leg | 1(Do) |
| Lift a right leg | 2(Re) |
| Lift a left arm | 3(Mi) |
| Lift a right arm | 4(Fa) |
| Lift a left arm over a shoulder | 5(So) |
| Lift a right arm over a shoulder | 6(La) |
| T-shape (that is, left and right arms are flush with | 7(Si) |
| a shoulder, and left and right legs stand upright) | |

For instance, the duration of the target scale may be determined according to the duration of the first action.

In addition, after the scale information of the target scale corresponding to the first action is determined, the target music may be generated according to the scale information of the target scale.

In a possible implementation, after the target music is generated in S203, the method may further include the following step: playing the target music. In this way, the first user may listen to an effect of the target music in time. Particularly, in a scenario of the method one (that is, the music generation process and the video capture process are conducted synchronously), when the first user thinks that the effect of the target music is undesirable by listening to the target music, the first user may adjust the action in real time to modify or adjust the target music, such that music creation efficiency of the user is improved, and user experience is enhanced.

The method for generating music according to the embodiment may include the following steps: acquiring a first video of the first user captured within the preset duration; determining action information of the first action performed by the first user within the preset duration according to the first video, the action information includes an action type and a duration of action; and generating target music corresponding to the preset duration according to the action information of the first action. In the above process, the user may interact with the terminal device by executing a series of actions, so as to create music, which improves interactivity and pleasure and may further enhance user experience.

Based on the embodiment, the technical solution of the present disclosure will be described in more details below in conjunction with a more specific embodiment.

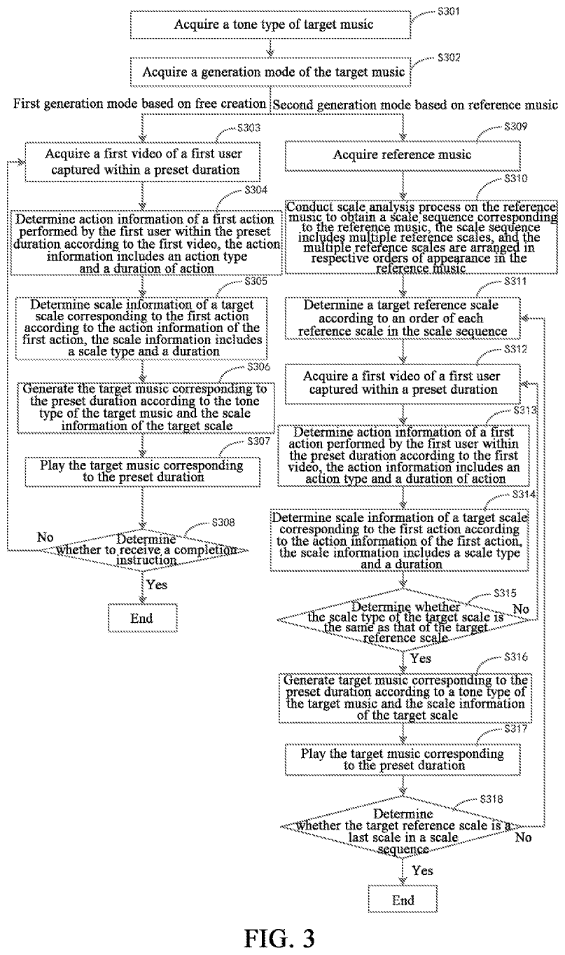

FIG. 3 is a schematic flow diagram of another method for generating music according to an embodiment of the present disclosure. As shown in FIG. 3, the method of the embodiment may include the following steps:

S301: acquiring a tone type of target music.

The target music is music to be created/generated. The tone type of the target music may be any of the following tones: a piano tone, an accordion tone, a violin tone, a harmonica tone, etc.

S302: acquiring a generation mode of the target music.

The generation mode is a first generation mode based on free creation or a second generation mode based on reference music.

In the first generation mode, the first user may freely organize a sequence of actions and a duration of each action. That is, the first user is not constrained in the music creation process, and may create music completely according to his/her own preferences.

In the second generation mode, the first user needs to organize a sequence of actions based on a scale sequence in reference music, and adjust duration of each scale in the reference music according to a duration of each action, so as to generate the target music. In this way, the generated target music is equivalent to an adaptation of a rhythm of the reference music.

In a possible implementation, the terminal device may receive a tone type of target music input by the first user and a generation mode of the target music input by the first user.

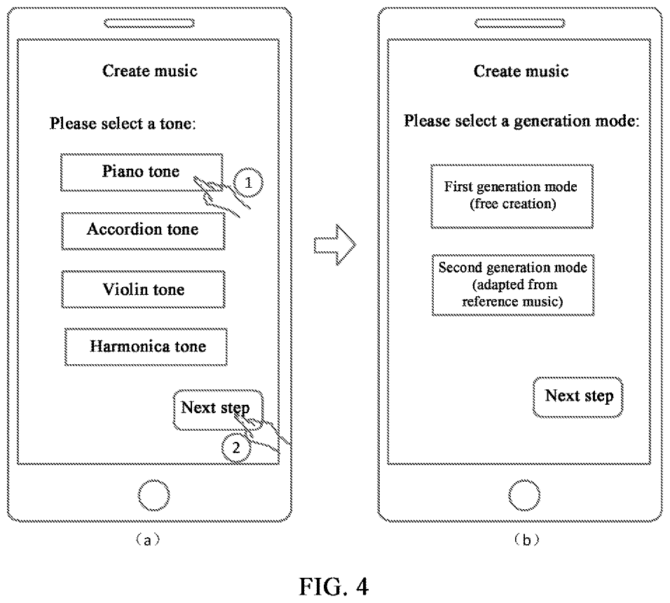

For example, FIG. 4 is a schematic diagram of a display interface according to an embodiment of the present disclosure. As shown in FIG. 4, a terminal device may show a user a first interface as shown in FIG. 4(a). Multiple options of tone types are provided in the first interface, and the user may select a tone type of the target music in the first interface according to creation needs. For example, it is assumed that the user selects a “piano tone” in the first interface. When the user clicks on “next step,” the terminal device may display a second interface as shown in FIG. 4(b). The terminal device provides options of the generation mode in the second interface, and the user may select a generation mode of the target music in the second interface according to creation needs.

The music generation process under the two generation modes will be described respectively below.

(1) If a generation mode of target music is a first generation mode, the following S303 to S308 are executed.

S303: acquiring a first video of a first user captured within a preset duration.

S304: determining action information of a first action performed by the first user within the preset duration according to the first video, the action information includes an action type and a duration of action.

S305: determining scale information of a target scale corresponding to the first action according to the action information of the first action, the scale information includes a scale type and a duration.

It should be understood that an embodiment of S303 to S305 is similar to the embodiment shown in FIG. 2, which will not be repeated herein.

S306: generating target music corresponding to the preset duration according to a tone type of the target music and the scale information of the target scale.

S307: playing the target music corresponding to the preset duration.

It may be understood that the above S303 to S307 may be repeatedly executed for multiple rounds. In each round of execution, the user may execute the first action, and the terminal device determines the scale information of the target scale according to the action information of the first action. In this way, scale information of the target scale determined in the multiple rounds of execution forms the target music created by the user.

S308: determining whether to receive a completion instruction.

If yes, the process is ended. Otherwise, the method returns to S303.

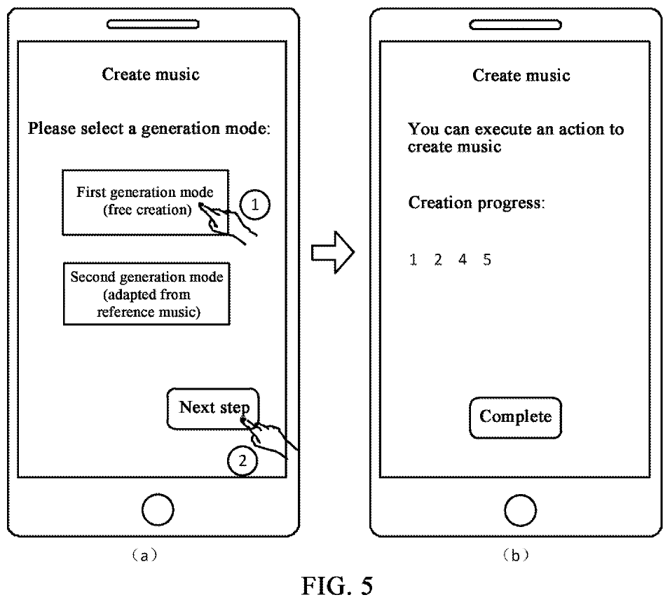

For instance, FIG. 5 is a schematic diagram of another display interface according to an embodiment of the present disclosure. As shown in FIG. 5, it is assumed that the user selects the “first generation mode” in the second interface as shown in FIG. 5(a). When the user clicks on “next step,” the terminal device displays a third interface as shown in FIG. 5(b). Current creation progress is displayed in the third interface. For instance, assuming that a first action performed by the user is “lifting a left leg,” the target scale determined by the terminal device is “1.” Assuming that a second action performed by the user is “lifting a right leg,” the target scale determined by the terminal device is “2.” Assuming that a third action performed by the user is “lifting a right arm (not over a shoulder),” the target scale determined by the terminal device is “4.” Assuming that a fourth action performed by the user is “lifting a left arm (over a shoulder),” the target scale determined by the terminal device is “5.” In this way, with reference to FIG. 5(b), the current creation progress is “1 2 4 5”.

It should be noted that in the third interface shown in FIG. 5(b), the creation progress may be displayed in various modes, such as a scale sequence form and a notation form, which is not limited in the embodiment.

When the user completes creation, the user may click on a “Complete” button in the third interface shown in FIG. 5(b). In this way, the terminal device receives the completion instruction and determines that creation of the target music is completed.

(2) If a generation mode of target music is the second generation mode, the following S309 to S318 are executed.

S309: acquiring reference music.

The reference music is music that needs to be adapted to generate the target music. The reference music may be specified by the user or randomly determined by the terminal device.

S310: conducting scale analysis process on the reference music to obtain a scale sequence corresponding to the reference music, the scale sequence includes multiple reference scales, and the multiple reference scales are arranged according to respective orders of appearance in the reference music.

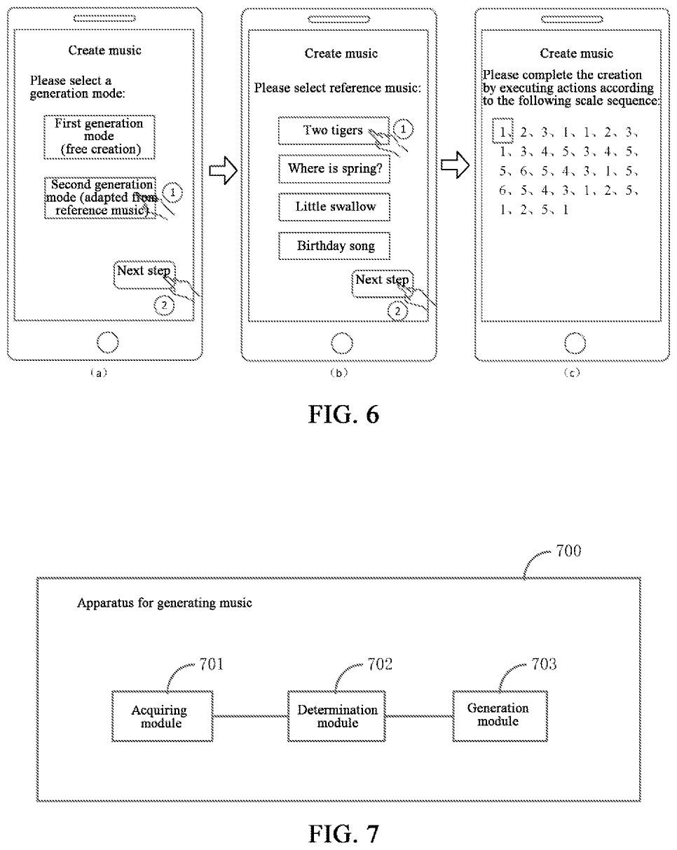

In a possible implementation, the terminal device may receive the reference music input by the first user. For instance, FIG. 6 is a schematic diagram of yet another display interface according to an embodiment of the present disclosure. As shown in FIG. 6, it is assumed that the user selects the “second generation mode” in the second interface as shown in FIG. 6(a). When the user clicks on “next step,” the terminal device displays a fourth interface as shown in FIG. 6(b). The terminal device displays a selection control for the user to select the reference music in the fourth interface. The user may input the reference music to the terminal device by means of the selection control. Alternatively, the terminal device may display an input control in the fourth interface, such that the user may further input a name of the reference music to the terminal device by means of the input control. Alternatively, the user may input the reference music to the terminal device by voice. The method for inputting the reference music is not limited by the embodiment of the present disclosure.

Further, with reference to FIG. 6, assuming that the user selects the reference music “Two tigers” in the fourth interface shown in FIG. 6(b), the terminal device conducts scale analysis on the reference music, and obtain reference scales that appear sequentially in the reference music. The following scale sequence is formed according to orders of appearance of the reference scales.

1, 2, 3, 1, 1, 2, 3, 1, 3, 4, 5, 3, 4, 5, 5, 6, 5, 4, 3, 1, 5, 6, 5, 4, 3, 1, 2, 5, 1, 2, 5, 1.

In addition, with reference to FIG. 6, after the user selects the reference music “Two tigers” and clicks on “Next step,” the terminal device may display a fifth interface as shown in FIG. 6(c), and the scale sequence is displayed in the fifth interface. In this way, the user may perform actions corresponding to the reference scales according to the order of each reference scale in the scale sequence displayed in the fifth interface.

S311: determining a target reference scale according to the order of each reference scale in the scale sequence.

In the embodiment, S311 to S318 may be repeatedly executed for multiple rounds. During the first execution, a first reference scale in the scale sequence is determined to be the target reference scale. During second execution, a second reference scale in the scale sequence is determined to be the target reference scale. The rest may be implemented in the same manner. Accordingly, in each round of execution, the user needs to execute an action corresponding to the target reference scale.

Alternatively, in the fifth interface shown in FIG. 6(c), the target reference scale may be highlighted (for instance, the target reference scale is located in a rectangular box in FIG. 6(c)), which is more intuitively to remind the user of the current creation progress and the action that needs to be executed currently.

S312: acquiring a first video of a first user captured within a preset duration.

S313: determining action information of a first action performed by the first user within the preset duration according to the first video, the action information includes an action type and a duration of action.

S314: determining scale information of a target scale corresponding to the first action according to the action information of the first action, the scale information includes a scale type and duration.

It should be understood that implementations of S312 to S314 are similar to the embodiments shown in FIG. 2, which will not be repeated herein.

S315: determining whether the scale type of the target scale is the same as that of the target reference scale.

If yes, S316 is executed.

If no, the method returns to S312.

In the embodiment, when the user selects the second generation mode, the user needs to execute a corresponding action according to the order of each reference scale in the reference music. Therefore, in each round of execution, it needs to determine whether the scale type of the target scale is the same as that of the target reference scale. If yes, S316 may be executed. If no, the method returns to S312, and the action performed by the user is re-detected.

Alternatively, in the case that the scale type of the target scale is different from that of the target reference scale, the terminal device may display a prompt message in the fifth interface shown in FIG. 6(c), for instance, “the current action is incorrect, please perform the again,” such that the user may be reminded of timely adjustment.

S316: generating target music corresponding to the preset duration according to a tone type of the target music and the scale information of the target scale.

S317: playing the target music corresponding to the preset duration.

S318: determining whether the target reference scale is the last scale in a scale sequence.

If yes, it is indicated that creation based on the reference music is completed and the process is ended.

If no, the method returns to S311.

It should be noted that in the second generation mode, the scale sequence in the generated target music is the same as that in the reference music, and a duration of each scale of the generated target music is different from that of the reference music. That is, a rhythm of the target music is different from the reference music. In this way, the target music may be regarded as an adaptation of the rhythm of the reference music.

In the embodiment, the user may interact with the terminal device by performing a series of actions, so as to create music, which improves interactivity and pleasure and may further enhance user experience. Further, the user may create music with the first generation mode based on free creation or the second generation mode based on reference music, which further improves pleasure of music creation.

FIG. 7 is a schematic structural diagram of an apparatus for generating music according to an embodiment of the present disclosure. The apparatus may be in a form of software and/or hardware. The apparatus may be a terminal device, or a processor, a chip, a chip module, a module, a unit, an application, etc. integrated into the terminal device.

As shown in FIG. 7, the apparatus 700 for generating music according to the embodiment may include: an acquiring module 701, a determination module 702, and a generation module 703.

The acquiring module 701 is configured to acquire a first video of a first user captured within a preset duration.

The determination module 702 is configured to determine action information of a first action performed by the first user within the preset duration according to the first video. The action information includes an action type and a duration of action.

The generation module 703 is configured to generate target music corresponding to the preset duration according to the action information of the first action.

In a possible implementation, the generation module 703 is specifically configured to:
determine scale information of a target scale corresponding to the first action according to the action information of the first action, the scale information includes a scale type and duration; and
generate the target music according to the scale information of the target scale.

In a possible implementation, the generation module 703 is specifically configured to:
determine the scale type of the target scale according to the action type of the first action and a preset correspondence, the preset correspondence is configured to indicate a correspondence between different action types and different scale types; and
determine a duration of the target scale according to a duration of the first action.

In a possible implementation, the acquiring module 701 is further configured to obtain a generation mode of the target music, the generation mode is a first generation mode based on free creation or a second generation mode based on reference music.

The generation module 703 is specifically configured to generate the target music according to the generation mode of the target music and the scale information of the target scale.

In a possible implementation, the generation module 703 is specifically configured to:
in response to the generation mode of the target music being the first generation mode, generate the target music according to the scale information of the target scale; or
in response to the generation mode of the target music being the second generation mode, determine a target reference scale from the reference music, and in response to the scale type of the target scale being the same as that of the target reference scale, generate the target music according to the scale information of the target scale.

In a possible implementation, the acquiring module 701 is further configured to: acquire the reference music; and conduct scale analysis process on the reference music to obtain a scale sequence corresponding to the reference music. The scale sequence includes multiple reference scales, and the multiple reference scales are arranged according to respective orders of appearance in the reference music.

The generation module 703 is specifically configured to determine the target reference scale according to an order of each reference scale in the scale sequence.

In a possible implementation, the generation module 703 is specifically configured to:
acquire a tone type of the target music; and
generate the target music according to the tone type and the scale information of the target scale.

In a possible implementation, the apparatus further includes:
a playing module configured to play the target music.

In a possible implementation, the determination module 702 is specifically configured to:
determine a target body part, the target body part includes at least one of the following parts of the first user: limbs and a trunk, a hand, and a face;
detect feature information of the target body part in multiple frames of the first video respectively; and
determine the action information of the first action according to the feature information of the target body part detected in the multiple frames.

The apparatus for generating music according to the embodiment may be configured to execute the method for generating music according to any of the method embodiments, and has similar implementation principle and technical effect to those of the method embodiments, which will not be repeated herein.

In order to implement the embodiments, an embodiments of the present disclosure further provides an electronic device.

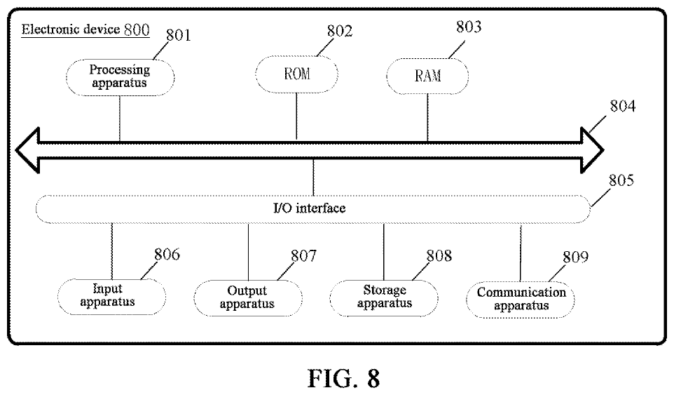

FIG. 8 shows a schematic structural diagram of an electronic device 800 suitable for implementing embodiments of the present disclosure. The electronic device 800 may be a terminal device or a server. The terminal device may be, but is not limited to, a mobile terminal such as a mobile phone, a notebook computer, a digital broadcast receiver, a personal digital assistant (PDA), a portable android device (PAD), a portable media player (PMP), or a vehicle-mounted terminal (for instance, a vehicle-mounted navigation terminal), and a fixed terminal such as a digital television (TV) or a desktop computer. The electronic device shown in FIG. 8 is only illustrative, and is not intended to limit functions and application scopes of embodiments of the present disclosure.

As shown in FIG. 8, the electronic device 800 may include a processing apparatus (for instance, a central processing unit or a graphics processing unit) 801, which may execute various appropriate actions and processing according to a program stored in a read only memory (ROM) 802 or a program loaded from a storage apparatus 808 to a random access memory (RAM) 803. The RAM 803 further stores various programs and data required for operations of the electronic device 800. The processing apparatus 801, the ROM 802 and the RAM 803 are connected to one another by means of a bus 804. An input/output (I/O) interface 805 is further connected to the bus 804.

Generally, the following apparatuses may be connected to the I/O interface 805: an input apparatus 806 including, for instance, a touch screen, a touch pad, a keyboard, a mouse, a camera, a microphone, an accelerometer, a gyroscope, etc.; an output apparatus 807 including, for instance, a liquid crystal display (LCD), a speaker, a vibrator, etc.; the storage apparatus 808 including, for instance, a magnetic tape, a hard disk, etc.; and a communication apparatus 809. The communication apparatus 809 may allow the electronic device 800 to be in wireless or wired communication with other devices so as to implement data exchange. Although FIG. 8 shows the electronic device 800 including various apparatuses, it should be understood that not all the apparatuses shown are required to be implemented or included. More or fewer apparatuses may be alternatively implemented or included.

Particularly, according to embodiments of the present disclosure, the process described above with reference to the flow diagram may be implemented to be a computer software program. For instance, an embodiment of the present disclosure includes a computer program product, which includes a computer program carried by a computer-readable medium. The computer program includes a program code configured to execute the method shown in the flow diagram. In such an embodiment, the computer program may be downloaded and configured from a network through the communication apparatus 809, or configured from the storage apparatus 808, or configured from the ROM 802. The computer program executes the functions defined in the method according to embodiments of the present disclosure when being executed by the processing apparatus 801.

It should be noted that the computer-readable medium described in the present disclosure may be a computer-readable signal medium, or a computer-readable storage medium, or any combination thereof. For instance, the computer-readable storage medium may be, but is not limited to, an electronic, magnetic, optical, electromagnetic, infrared, or semiconductor system, apparatus, or device, or any suitable combination thereof. More specific instances of the computer-readable storage medium may include, but are not limited to, an electrical connection having on one or more wires, a portable computer disk, a hard disk, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination thereof. In the present disclosure, the computer-readable storage medium may be any tangible medium including or storing a program. The program may be used by or in combination with an instruction execution system, apparatus or device. In the present disclosure, the computer-readable signal medium may include a data signal in a baseband or as part of a carrier for transmission, and the data signal carries a computer-readable program code. The transmitted data signal may be in various forms, which may be, but is not limited to, an electromagnetic signal, an optical signal, or any suitable combination thereof. The computer-readable signal medium may further be any computer-readable medium other than the computer-readable storage medium. The computer-readable signal medium may transmit, propagate or transmit a program used by or in combination with an instruction execution system, apparatus or device. The program code included in the computer-readable medium may be transmitted by any suitable medium, including, but not limited to, an electric wire, an optical cable, radio frequency (RF), etc., or any suitable combination thereof.

The computer-readable medium may be included in the electronic device, or may exist independently without being assembled into the electronic device.

The computer-readable medium carries one or more programs. The one or more programs, when being executed by the electronic device, enable the electronic device to execute the method shown in embodiments.

A computer program code configured to execute an operation of the present disclosure may be written in one or more programming languages or a combination thereof. The programming languages include object-oriented programming languages such as Java, Smalltalk, and C++, and further include conventional procedural programming languages such as “C” or similar programming languages. The program code may be executed entirely on a user computer, executed partially on a user computer, executed as a stand-alone software package, executed partially on a user computer and partially on a remote computer, or executed entirely on the remote computer or a server. In the case involving the remote computer, the remote computer may be connected to the user computer through any type of networks including a local area network (LAN) or a wide area network (WAN), or may be connected to an external computer (for instance, the remote computer is connected through the Internet by an Internet service provider).

The flow diagrams and block diagrams in the accompanying drawings illustrate system structures, functions and operations, which may be implemented according to systems, methods and computer program products in all the embodiments of the present disclosure. In view of that, each block in the flow diagrams or block diagrams may represent a module, a program segment, or part of a code, which includes one or more executable instructions configured to implement specified logic functions. It should further be noted that in some alternative implementations, the functions noted in the blocks may also occur in an order different from that in the accompanying drawings. For instance, the functions represented by two continuous blocks may be actually implemented basically in parallel, or may be implemented in reverse orders, which depends on the involved functions. It should further be noted that each block in the block diagrams and/or flow diagrams and combinations of the blocks in the block diagrams and/or the flow diagrams may be implemented with dedicated hardware-based systems that implement the specified functions or operations, or may be implemented with combinations of dedicated hardware and computer instructions.

The units involved in embodiments described in the present disclosure may be implemented by software or hardware. Names of the units do not limit the units themselves in some cases. For example, a first acquiring unit may also be described to be “a unit acquiring at least two Internet protocol addresses.”

The functions described herein may be at least partially executed by one or more hardware logic components. For instance, for the nonrestrictive purposes, illustrative types of hardware logic components that may be used may include: a field programmable gate array (FPGA), an application specific integrated circuit (ASIC), application specific standard parts (ASSPs), a system on chip (SOC), a complex programmable logic device (CPLD), etc.

In the context of the present disclosure, the machine-readable medium may be a tangible medium, which may include or store a program used by or used in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific instances of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination thereof.

In a first aspect, one or more embodiments of the present disclosure provide a method for generating music. The method includes the following steps:
acquiring a first video of a first user captured within a preset duration;
determining action information of a first action performed by the first user within the preset duration according to the first video, the action information includes an action type and a duration of action; and
generating target music corresponding to the preset duration according to the action information of the first action.

According to one or more embodiments of the present disclosure, the step of generating the target music corresponding to the preset duration according to the action information of the first action includes the following steps:
determining scale information of a target scale corresponding to the first action according to the action information of the first action, the scale information includes a scale type and a duration; and
generating the target music according to the scale information of the target scale.

According to one or more embodiments of the present disclosure, the step of determining the scale information of the target scale corresponding to the first action according to the action information of the first action includes the following steps:
determining the scale type of the target scale according to the action type of the first action and a preset correspondence, the preset correspondence is configured to indicate a correspondence between different action types and different scale types; and
determining a duration of the target scale according to the duration of the first action.

According to one or more embodiments of the present disclosure, before the step of acquiring the first video of the first user captured within the preset duration, the method further includes the following step:
acquiring a generation mode of the target music, the generation mode is a first generation mode based on free creation or a second generation mode based on reference music.

Accordingly, the step of generating the target music according to the scale information of the target scale includes the following step:
generating the target music according to the generation mode of the target music and the scale information of the target scale.

According to one or more embodiments of the present disclosure, the step of generating the target music according to the generation mode of the target music and the scale information of the target scale includes the following steps:
in response to the generation mode of the target music being the first generation mode, generating the target music according to the scale information of the target scale; or,
in response to the generation mode of the target music being the second generation mode, determining a target reference scale from the reference music, and in response to the scale type of the target scale being the same as that of the target reference scale, generating the target music according to the scale information of the target scale.

According to one or more embodiments of the present disclosure, before the step of determining the target reference scale from the reference music, the method further includes the following steps:
acquiring the reference music; and
conducting scale analysis process on the reference music to obtain a scale sequence corresponding to the reference music, the scale sequence includes multiple reference scales, and the multiple reference scales are arranged according to respective orders of appearance in the reference music.

Accordingly, the step of determining the target reference scale from the reference music includes the following step:
determining the target reference scale according to the order of each reference scale in the scale sequence.

According to one or more embodiments of the present disclosure, the step of generating the target music according to the scale information of the target scale includes the following steps:
acquiring a tone type of the target music; and
generating the target music according to the tone type and the scale information of the target scale.

According to one or more embodiments of the present disclosure, after the step of generating the target music according to the scale information of the target scale, the method further includes the following step:
playing the target music.

According to one or more embodiments of the present disclosure, the step of determining the action information of the first action performed by the first user within the preset duration according to the first video includes the following steps:
determining a target body part, where the target body part includes at least one of the following parts of the first user: limbs and trunk, a hand, and a face;
detecting feature information of the target body part in multiple frames of the first video respectively; and
determining the action information of the first action according to the feature information of the target body part detected in the multiple frames.

In a second aspect, one or more embodiments of the present disclosure provide an apparatus for generating music. The apparatus includes:
an acquiring module configured to acquire a first video of a first user captured within a preset duration;
a determination module configured to determine action information of a first action performed by the first user within the preset duration according to the first video, the action information includes an action type and a duration of action; and
a generation module configured to generate target music corresponding to the preset duration according to the action information of the first action.

According to one or more embodiments of the present disclosure, the generation module is specifically configured to:
determine scale information of a target scale corresponding to the first action according to the action information of the first action, the scale information includes a scale type and a duration; and
generate the target music according to the scale information of the target scale.

According to one or more embodiments of the present disclosure, the generation module is specifically configured to:
determine the scale type of the target scale according to an action type of the first action and a preset correspondence, where the preset correspondence is configured to indicate a correspondence between different action types and different scale types; and
determine a duration of the target scale according to a duration of the first action.

According to one or more embodiments of the present disclosure, the acquiring module is further configured to obtain a generation mode of the target music, the generation mode is a first generation mode based on free creation or a second generation mode based on reference music.

The generation module is specifically configured to generate the target music according to the generation mode of the target music and the scale information of the target scale.

According to one or more embodiments of the present disclosure, the generation module is specifically configured to:
in response to the generation mode of the target music being the first generation mode, generate the target music according to the scale information of the target scale; or
in response to the generation mode of the target music being the second generation mode, determine a target reference scale from the reference music, and in response to the scale type of the target scale being the same as that of the target reference scale, generate the target music according to the scale information of the target scale.

According to one or more embodiments of the present disclosure, the acquiring module is further configured to acquire the reference music; and conduct scale analysis process on the reference music to obtain a scale sequence corresponding to the reference music. The scale sequence includes multiple reference scales, and the multiple reference scales are arranged in respective orders of appearance in the reference music.

The generation module is specifically configured to determine the target reference scale according to the order of each reference scale in the scale sequence.

According to one or more embodiments of the present disclosure, the generation module is specifically configured to:
acquire a tone type of the target music; and
generate the target music according to the tone type and the scale information of the target scale.

According to one or more embodiments of the present disclosure, the apparatus further includes:
a playing module configured to play the target music.

According to one or more embodiments of the present disclosure, the determination module is specifically configured to:
determine a target body part, the target body part includes at least one of the following parts of the first user: limbs and trunk, a hand, and a face;
detect feature information of the target body part in multiple frames of the first video respectively; and
determine the action information of the first action according to the feature information of the target body part detected in the multiple image frames.

In a third aspect, one or more embodiments of the present disclosure provide an electronic device. The electronic device includes: at least one processor and a memory.

The memory stores computer-executable instructions.

The at least one processor executes the computer-executable instructions stored in the memory, such that the at least one processor executes the method for generating music according to the first aspect and various possible implementations of the first aspect.

In a fourth aspect, one or more embodiments of the present disclosure provide a computer-readable storage medium. The computer-readable storage medium stores computer-executable instructions. A processor implements the method for generating music according to the first aspect and various possible implementations of the first aspect when executing the computer-executable instructions.

In a fifth aspect, one or more embodiments of the present disclosure provide a computer program product. The computer program product includes a computer program. The computer program, when being executed by a processor, implements the method for generating music according to the first aspect and various possible implementations of the first aspect.

In a sixth aspect, one or more embodiments of the present disclosure provide a computer program. The computer program, when being executed by a processor, implements the method for generating music according to the first aspect and various possible implementations of the first aspect.

What are described above are merely illustrative of preferred embodiments of the present disclosure and principles of the technology employed. Those skilled in the art should understand that the present disclosure scope of the present disclosure is not limited to the technical solution formed by a specific combination of the technical features described above, and should further cover other technical solutions formed by any combination of the technical features described above or their equivalent features without departing from the disclosed concept, for instance, the technical solution formed by replacing the features with the technical features having similar functions disclosed in (but not limited to) the present disclosure or vice versa.

Further, although operations are depicted in a particular order, it should be understood that the operations are not required to be executed in the particular order shown or in a sequential order. In some cases, multitasking and parallel processing may be advantageous. Likewise, although several specific implementation details are included in the above discussion, the details should not be construed as limiting the scope of the present disclosure. Some features described in the context of separate examples may also be implemented in combination in a single example. On the contrary, various features described in the context of a single example may also be implemented in multiple examples independently or in any suitable sub-combination manner.

Although the subject is described in languages of specific structural features and/or methodological logic actions, it should be understood that the subject defined in the appended claims is not necessarily limited to the specific features or actions described above. On the contrary, the specific features and actions described above are merely illustrative forms for implementing the claims.

What is claimed is:

1. A method for generating music, comprising:
acquiring a first video of a first user captured within a preset duration;
determining action information of a first action performed by the first user within the preset duration according to the first video, the action information comprises an action type and a duration of action; and
generating target music corresponding to the preset duration according to the action information of the first action.

2. The method according to claim 1, wherein generating target music corresponding to the preset duration according to the action information of the first action comprises:
determining scale information of a target scale corresponding to the first action according to the action information of the first action, the scale information comprises a scale type and duration; and
generating the target music according to the scale information of the target scale.

3. The method according to claim 2, wherein determining scale information of a target scale corresponding to the first action according to the action information of the first action comprises:
determining the scale type of the target scale according to the action type of the first action and a preset correspondence, the preset correspondence is configured to indicate a correspondence between different action types and different scale types; and
determining a duration of the target scale according to the duration of the first action.

4. The method according to claim 2, wherein before acquiring the first video of the first user captured within the preset duration, the method further comprises:
acquiring a generation mode of the target music, the generation mode is a first generation mode based on free creation or a second generation mode based on reference music; and
generating the target music according to the scale information of the target scale comprises:
generating the target music according to the generation mode of the target music and the scale information of the target scale.

5. The method according to claim 4, wherein generating the target music according to the generation mode of the target music and the scale information of the target scale comprises:
in response to the generation mode of the target music being the first generation mode, generating the target music according to the scale information of the target scale; or
in response to the generation mode of the target music being the second generation mode, determining a target reference scale from the reference music, and in response to the scale type of the target scale being the same as that of the target reference scale, generating the target music according to the scale information of the target scale.

6. The method according to claim 5, wherein before determining the target reference scale from the reference music, the method further comprises:
acquiring the reference music; and
conducting scale analysis process on the reference music to obtain a scale sequence corresponding to the reference music, the scale sequence comprises a plurality of reference scales, and the plurality of reference scales are arranged in respective orders of appearance in the reference music; and
determining a target reference scale from the reference music comprises:
determining the target reference scale according to an order of each reference scale in the scale sequence.

7. The method according to claim 2, wherein generating the target music according to the scale information of the target scale comprises:
acquiring a tone type of the target music; and
generating the target music according to the tone type and the scale information of the target scale.

8. The method according to claim 2, wherein after generating the target music according to the scale information of the target scale, the method further comprises:
playing the target music.

9. The method according to claim 1, wherein determining action information of the first action performed by the first user within the preset duration according to the first video comprises:
determining a target body part, the target body part comprises at least one of the following parts of the first user: limbs and trunk, a hand, and a face;
detecting feature information of the target body part in a plurality of frames of the first video respectively; and
determining the action information of the first action according to the feature information of the target body part detected in the plurality of frames.

10. (canceled)

11. An electronic device, comprising: a processor and a memory,
the memory stores computer-executable instructions; and
the processor executes the computer-executable instructions to:
acquire a first video of a first user captured within a preset duration;
determine action information of a first action performed by the first user within the preset duration according to the first video, the action information comprises an action type and a duration of action; and
generate target music corresponding to the preset duration according to the action information of the first action.

12. A non-transitory computer-readable storage medium, storing computer-executable instructions, the computer-executable instructions, when being executed by a processor, cause the processor to:
acquire a first video of a first user captured within a preset duration;
determine action information of a first action performed by the first user within the preset duration according to the first video, the action information comprises an action type and a duration of action; and
generate target music corresponding to the preset duration according to the action information of the first action.

13-14. (canceled)

15. The electronic device according to claim 11, wherein the electronic device being caused to generate target music corresponding to the preset duration according to the action information of the first action comprises being caused to:
determine scale information of a target scale corresponding to the first action according to the action information of the first action, the scale information comprises a scale type and duration; and
generate the target music according to the scale information of the target scale.

16. The electronic device according to claim 15, wherein the electronic device being caused to determine scale information of a target scale corresponding to the first action according to the action information of the first action comprises being caused to:
determine the scale type of the target scale according to the action type of the first action and a preset correspondence, the preset correspondence is configured to indicate a correspondence between different action types and different scale types; and
determine a duration of the target scale according to the duration of the first action.

17. The electronic device according to claim 15, wherein before being caused to acquire the first video of the first user captured within the preset duration, the electronic device is further caused to:
acquire a generation mode of the target music, the generation mode is a first generation mode based on free creation or a second generation mode based on reference music; and
generate the target music according to the scale information of the target scale comprises:
generate the target music according to the generation mode of the target music and the scale information of the target scale.

18. The electronic device according to claim 17, wherein the electronic device being caused to generate the target music according to the generation mode of the target music and the scale information of the target scale comprises being caused to:
in response to the generation mode of the target music being the first generation mode, generate the target music according to the scale information of the target scale; or
in response to the generation mode of the target music being the second generation mode, determine a target reference scale from the reference music, and in response to the scale type of the target scale being the same as that of the target reference scale, generate the target music according to the scale information of the target scale.

19. The electronic device according to claim 18, wherein before being caused to determine the target reference scale from the reference music, the electronic device is further caused to:
acquire the reference music; and
conduct scale analysis process on the reference music to obtain a scale sequence corresponding to the reference music, the scale sequence comprises a plurality of reference scales, and the plurality of reference scales are arranged in respective orders of appearance in the reference music; and
determine a target reference scale from the reference music comprises:
determine the target reference scale according to an order of each reference scale in the scale sequence.

20. The electronic device according to claim 15, wherein the electronic device being caused to generate the target music according to the scale information of the target scale comprises being caused to:
acquire a tone type of the target music; and
generate the target music according to the tone type and the scale information of the target scale.

21. The electronic device according to claim 15, wherein after being caused to generate the target music according to the scale information of the target scale, the electronic device is further caused to:
play the target music.

22. The electronic device according to claim 11, wherein the electronic device being caused to determine action information of the first action performed by the first user within the preset duration according to the first video comprises being caused to:
determine a target body part, the target body part comprises at least one of the following parts of the first user: limbs and trunk, a hand, and a face;
detect feature information of the target body part in a plurality of frames of the first video respectively; and
determine the action information of the first action according to the feature information of the target body part detected in the plurality of frames.

23. The non-transitory computer-readable storage medium according to claim 12, the processor being caused to generate target music corresponding to the preset duration according to the action information of the first action comprises being caused to:
determine scale information of a target scale corresponding to the first action according to the action information of the first action, the scale information comprises a scale type and duration; and
generate the target music according to the scale information of the target scale.
